(19) United States
(12) Patent Application Publication
(10) Pub. No.: US 2016/0072738 A1
(43) Pub. Date: Mar. 10, 2016

(54) System and methods for electronic communication between business entities

(71) Applicant: GRANT PATRICK HENDERSON, ANAHEIM, CA (US)

(72) Inventor: GRANT PATRICK HENDERSON, LAS VEGAS, NV (US)

(73) Assignee: GRANT PATRICK HENDERSON, ANAHEIM, CA (US)

(21) Appl. No.: 14/845,161

(22) Filed: Sep. 3, 2015

Related U.S. Application Data
(60) Provisional application No. 62/047,247, filed on Sep. 8, 2014.

(51) Int. Cl. H04L 12/58; H04L 29/06; H04L 29/08

(52) U.S. Cl. CPC H04L 51/04; H04L 67/306; H04L 69/26

(57) ABSTRACT

A system and methods for electronic communication between businesses, business representatives and people.

### CLAIM OF PRIORITY

This patent application claims the benefit of priority, under 35 U.S.C. Section 119(e), to U.S. Provisional Patent Application Ser. No. 62/047,247, entitled “System and methods for electronic communication between business entities,” filed on Sep. 8, 2014 to Henderson, which is hereby incorporated by reference herein in its entirety.

### CROSS REFERENCE TO RELATED APPLICATION

This application is related to copending application Ser. No. 14,845,051, filed Sep. 3, 2015, commonly assigned with the present invention.

### TECHNICAL FIELD

This invention relates to the fields of business management, information science and generally to a database of records compiled from entities with mutual common links and methods that transform these records.

### BACKGROUND OF THE INVENTION

To understand this invention, it is first necessary to understand problems associated with existing methods of electronic communication and how legal relationships can limit access to communication specifically related to business communication and transactions.

Legal Relationships

A Person entity (“Person” or plural “People”) is generally considered a legal entity with a physical embodiment.

A Business entity (plural “Businesses”) is generally considered a legal entity that may be represented by one or many other Person entities (including but not limited to employees, officers, agents, etc.), Business entities or other legal entities, and has no physical embodiment. A Business entity may use alternate names such as, company, corporation, trust, partnership, co-operative, association, etc.

A Person may be represented by other entities (e.g. via power of attorney), however, usually they represent themselves.

A Representative (simply described as “Representative”) is any entity, especially Person entities that represent a Business.

Representation by a Representative of a Business must be clear to avoid any misrepresentation by the Representative of the Business.

Actions and communications between People may not legally bind the Business they represent unless clear disclosure is made by each Person that they represent each Business. However, where clear disclosures are made by each Person that they have authority to represent a Business as a Representative, then their actions may legally bind that Business.

Electronic Mail

In electronic mail (e-mail), each message has a single sender and one or more recipients. The sender keeps a copy of each original message and each recipient receives a copy of each message sent. Each message is effectively duplicated and distributed.

In business communication, especially small business communication, it is common for Representatives to use their Personal email accounts and provide a signature that states they represent a Business. The message created is a Business asset but is not easily accessible by the Business as it is held in a Personal email account. As a result, the Business may have no direct record of each Business conversation making it difficult for other Representatives to audit or continue a conversation.

In larger Businesses, this is resolved by owning all email accounts (e.g. Google Apps for Business) or self-hosting a mail server (e.g. Microsoft™ Exchange™). While this may make the assets accessible, it is still inconvenient as each mailbox account must be accessed individually or shared with multiple Representatives and duplicate messages may be discovered across various mailboxes.

Current methods of email make it difficult to track multiple participants, especially when those participants are not People.

Forums and Social Network Conversations

A Forum is a public messaging service that allows conversations between multiple People. A Social Network (or Professional Network) is a model that describes relationships between People (e.g. Facebook™ or LinkedIn™).

An Enterprise Social Network (or Business Social Network) is a model that describes relationships between People within a Business (including employees, officers, agents, etc.) to each other or to a limited extent, external People that have been invited to participate in the Social Network (e.g. Yammer™).

In Social Network Conversations, each message has an original author and multiple participants, where each participant is usually a Person. A single sender creates a message and each participant is able to access the original message. There is no duplication of data.

Differences Between Social Networks and Business Networks

A Business Network is a model that describes relationships between Businesses and Representatives of those Businesses (e.g. RepX™)

Social and Business Networks differ by who they Represent. Social Networks comprise People representing themselves. Business Networks comprise Businesses that may be represented by Representatives who may be People or other entities.

Limitations of Electronic Mail, Forums and Social Network Communication

The limitations of Email, Forums and Social Network communication are that they:

do not clearly involve Business entities, unless the Business owns each Email and/or Social Network account (and, even then, accessing each of the Email and/or Social Network accounts can be laborious);

prohibit Businesses from auditing or accessing Business Communications that used Personal Email, Forum or Social Networking accounts; and

prevent other Representatives from finding and continuing Business Conversations.

What is needed is a method of including Business entities in every Business Conversation, so other Representatives can easily access each Business Conversation, and the Business and its Representatives can easily audit all Business Communications.

### SUMMARY OF THE INVENTION

The present invention teaches a system and methods that manage electronic communication between business entities, the entities that represent them, and people.

The system comprises:

a central database system that stores information about each entity, the relationships between entities, communication between entities and transactions performed between entities;

methods for storing and transforming information that involve entity relationships, entity communication and entity transactions;

computer servers (including server farms, and other scalable server technologies) and physical network connections (including but not limited to ethernet, wi-fi, and other electronic data networks) that facilitate electronic communication from the business communication system to any remote terminal (including but not limited to computer, mobile device, tablet, and other input/output devices).

### BRIEF DESCRIPTION OF THE DRAWINGS

FIG. 1 illustrates a computer system architecture, including the business communication system, its servers, database, methods, a computer network by which communication will occur, and the remote terminal of a Person or Representative.

FIG. 2 illustrates a computerized method for authentication and identification of a Representative.

FIG. 3 illustrates a representation of a set of People representing a Business.

FIG. 4 illustrates a database entity relationship diagram for the storage of a Business Conversation between People, Businesses and Representatives.

FIG. 5 illustrates a representation of a collection of Business Conversations.

FIG. 6 illustrates a representation of a Business Conversation.

FIG. 7 illustrates a computerized method for creating a Business Conversation.

FIG. 8 illustrates a computerized method to identify and read Business Conversations between two or more Participants

FIG. 9 illustrates a computerized method for adding Messages to a Business Conversation.

FIG. 10 illustrates a computerized method for Following a Business Conversation.

### DETAILED DESCRIPTION OF THE INVENTION

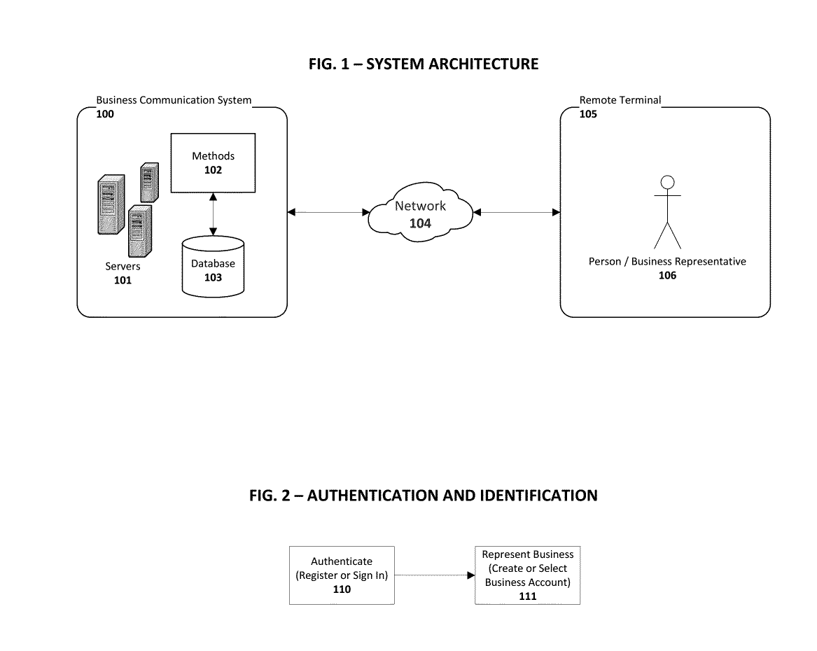

A block diagram of the business communication system is shown in FIG. 1.

The business communication system 100 comprises:

a database system 103 that stores information about each entity and about the relationships between entities;

methods 102 for storing and manipulating information involving entity relationships;

computer servers 101 (including server farms, distributed computers, and/or other scalable server technologies) and physical network connections 104 (including ethernet, wi-fi, and/or other electronic data networks) that facilitate electronic communication from the business networking system 100 to any remote terminal 105 (including, but not limited to, personal computers, server computers, mobile devices, tablets, and/or other input/output devices).

The methods 102 are executed by one or more data processors and processor memory within the computer servers 104 of the business communication system 100 that manipulate data stored in the database system 103 according to the rules of the method.

The methods 102 of the business communication system 100 are accessed and initiated via HyperText Markup Language (HTML), application programming interfaces (API), and/or other network and communications technologies at a Remote Terminal 105.

The business communication methods compromise:

Authentication and Identification

A method for authentication and identification is shown in FIG. 2.

A Person entity 106 (“person”, “user” or plural “people”, “users”) authenticates 110 with the business communication system 100 by providing a unique identifier (including email, username, account number, and/or other unique identifiers) and authorization key (including password, PIN, and/or other private keys), and agrees to abide by any required terms and conditions regarding use of the system.

A Person asserts that they represent a Business entity (“business” or plural “businesses”) 111, registers with the business communication system as a Representative of the Business, and agrees to abide by the terms and conditions of use on behalf of the Business. The Business has legal ownership of the business account and is legally bound by the agreement of its Representative.

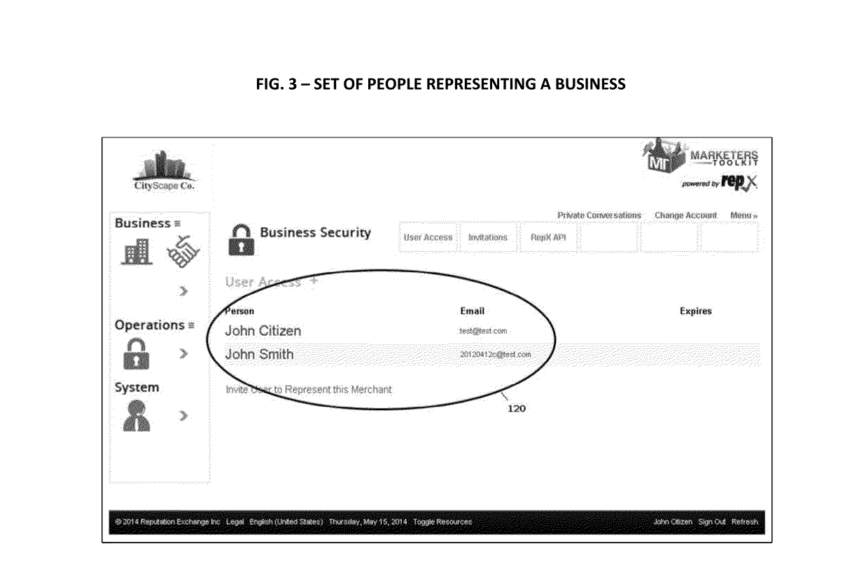

FIG. 3 illustrates a possible representation of a collection of Representatives for a Business 120. A Representative may invite other People to join a Business as authorized Representatives of that Business. Each such invited Person must then authenticate 110 as a Person to the business communication system 100 and agree, for both the Business they represent and for that Person individually, to abide by the required terms and conditions.

The purpose of business communication is to facilitate communication and transactions between multiple Representatives of multiple Businesses and clearly identify each Representative of each Business. This can include individual People that are not represented by any Business.

Business Conversations

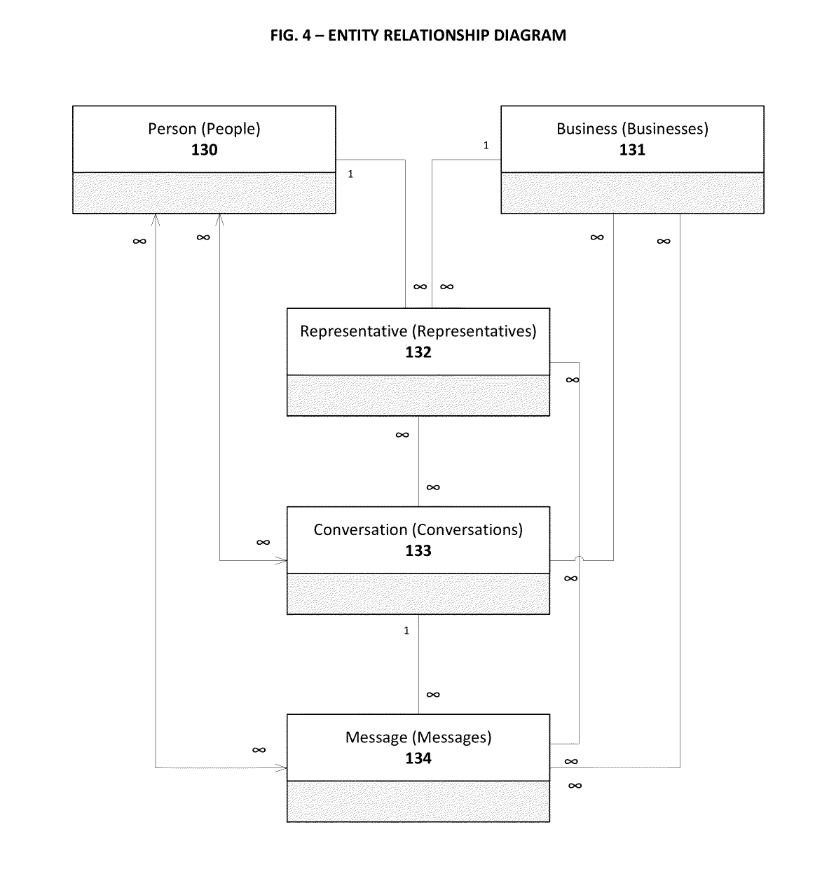

FIG. 4 illustrates a database entity relationship diagram for the storage of a Business Conversation.

A Business Conversation includes a Conversation, zero or more Messages and two or more Participants. Each Participant may be a Business and/or Representative and/or Person (independent of any business). Each Conversation 133, Message 134, Business 131, Representative 132 and Person 130 is stored in a corresponding database record and links are created between those database records.

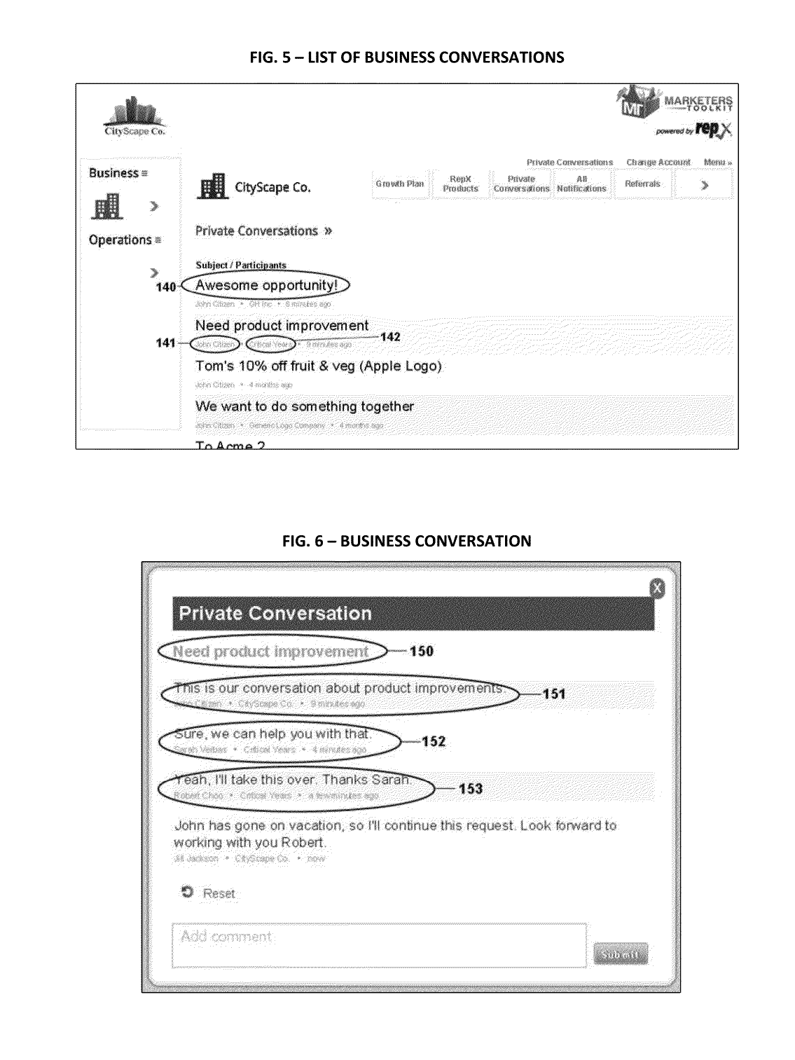

FIG. 5 illustrates a representation of a collection of Business Conversations. Each conversation item includes a Conversation with a Subject 140, one or more Representatives or People 141, and zero or more Businesses 142.

FIG. 6 illustrates a representation of a single Business Conversation. It includes a Conversation 150, and one or more messages 151 & 152 & 153, each identifying the Person and/or Business that wrote the message.

Create a Business Conversation

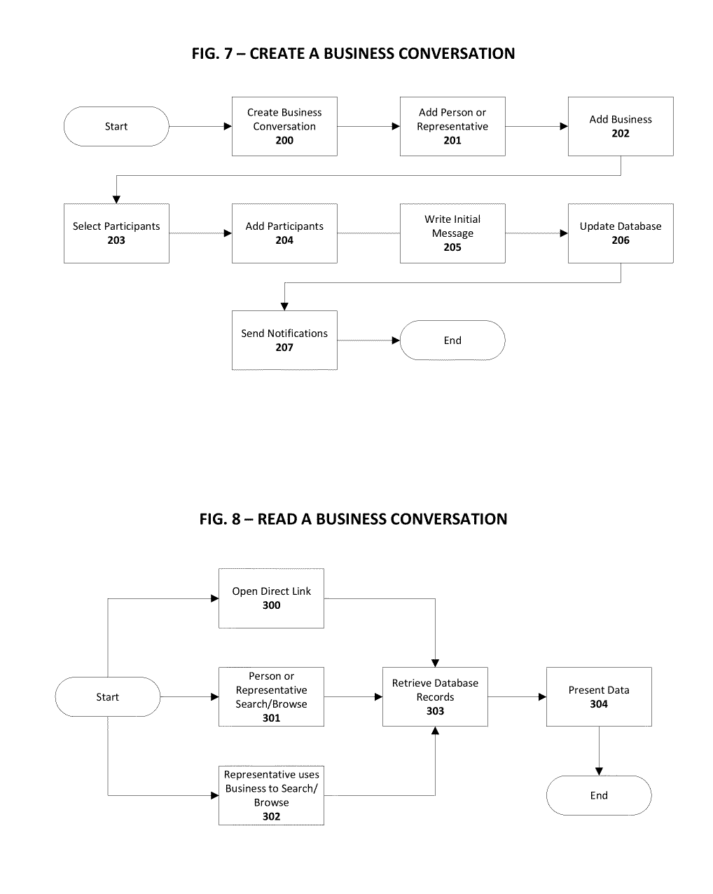

FIG. 7 illustrates a computerized method that initiates a Business Conversation between two or more Participants. A Participant may be a Business and/or Representative and/or Person.

A Business Conversation is created in computer memory 200.

A Person or Representative initiates a Business Conversation and is automatically added to the Business Conversation as a Person or Representative known to the System 201.

If the initiator is a Representative, the Business associated with the Representative is automatically added to the Business Conversation 202.

The Representative one or more Participants using sources including, but not limited to, address book, directory, business connection, or social profile; where a Participant may be a Person, Business or Representative 203.

The Participant is added to the Business Conversation 204. Where the Participant is a Business or a Person, only the respective Business or Person is added to the Business Conversation. Where the Participant is a Representative, both the Representative and the Business are added to the Business Conversation.

The Representative adds a Message 205, including, but not limited to, subject, body, custom fields, and/or attachments, to the Business Conversation. The initial Message could be stored within the Business Conversation itself 133 or within a separate database record 134.

The Representative submits the Business Conversation for storage. The Business Conversation 133 (optionally linked to the initial Message 134) is updated to the database 206, together with links to the Representative, Business, and all Participants including Businesses, Representatives and People.

The System sends Notifications to all Participants 207 using communication methods including, but not limited to, email, SMS, telephone, business network, or social network. The author of the Business Conversation may optionally receive a Notification.

Where the Participant is a Business, an optional Category field could be used to direct Notifications to specific Representatives or groups of Representatives (e.g. Sales, Accounts, etc.)

Read a Business Conversation

FIG. 8 illustrates a computerized method to identify and read Business Conversations between two or more Participants.

There exist three basic methods for identifying a Business Conversation:

A Business and/or Representative and/or Person receives a Notification with a direct link to the

Business Conversation 300.

A Person or Representative browses or searches Business Conversations that their respective database record is directly linked to 301.

A Representative uses its associated Business to browse or search for Business Conversations that the Business is linked to (and they are indirectly linked to) 302.

Once identified, the Business Conversation, Messages, Businesses, Representatives and People can each be retrieved from the database 303 and presented to the reader 304.

This method can be used by a Business to audit all Business Conversations that it participates in. An audit can identify Business Conversations initiated by and participated in by the Business plus each Representative of the Business.

Add a Message to a Business Conversation

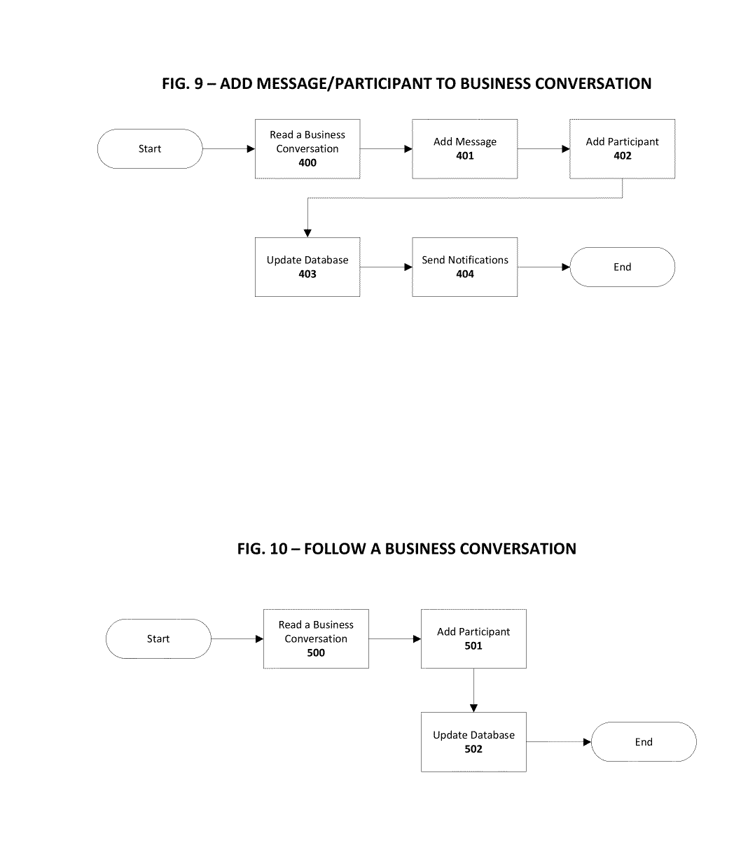

FIG. 9 illustrates a computerized method for adding Messages to a Business Conversation.

A Person or Representative identifies and reads a Business Conversation 400 & FIG. 8 300-304.

The Person or Representative adds a Message, including, but not limited to, subject, body, custom fields, and/or attachments, to the Business Conversation 401. The Person or Representative is linked to the Message. Where the author is a Representative, their corresponding Business is also linked to the Message.

If the Person or Representative is not already included in the Business Conversation (especially Representatives that identified the Business Conversation via their Business), the Person or Representative is added to the Business Conversation 402. Where the author is a Representative, their corresponding Business is also added to the Business Conversation.

The new Message is stored in the database 403 and linked to the Business Conversation in chronological order. New Person, Representative or Business links to Conversation and Message are stored in the database.

The System Send Notifications to all Participants 404 using communication methods including, but not limited to, email, SMS, telephone, business network, or social network. The author of the new Message may optionally receive a Notification.

Follow a Business Conversation

FIG. 10 illustrates a computerized method for following a Business Conversation.

A Person or Representative identifies and reads a Business Conversation 500 & FIG. 8 300-304.

If the Person or Representative is not already included in the Business Conversation (especially Representatives that identified the Business Conversation via their Business), the Person or Representative is added to the Business Conversation 501. Where the follower is a Representative, their corresponding Business is also linked to the Business Conversation.

New Person, Representative and Business links are stored in the database 502.

Public Business Conversations

A variation may include Business Conversations that are made public or at least available to a wider audience. A practical use for this would be a business forum where conversations occur between Businesses and their Representatives. As Representatives (e.g. employees) come and go, the Business itself can maintain an on-going presence. In this case, any Person or Representative may follow and/or add messages to the Business Conversation. Where the Business of a Representative is not already included in the Business Conversation, the Business will be added as a Participant so that other Representatives can easily find the Business Conversation or the Business can audit all Business Conversations.

Addition of Security

Messages and Participants in a Business Conversation can continue to be added without limitation. However, it may be practical to lock Business Conversations (made read-only) or in some way limit who has access to each Business Conversation (e.g. security on Representatives with relation to their Business).

Variations

A Business does not strictly have to be a legal entity. It could be any grouping of participants where the group itself is treated as a Business and is included in each Business Conversation.

Another embodiment includes tagging existing electronic communications with additional information (e.g., Business and Representative identifiers) and thereby implement the methods described in this invention. Such communications should be considered external communication entities.

Communication can be expanded to include any type of electronic transaction by virtue that each electronic transaction is a single communication transaction.

I claim:

1. A method for business communication comprising:
creating a plurality of representative entities that track relationships between business entities and people entities;
creating one or more business conversation entities;
determining by a participant that said participant is a representative of said business;
adding said business to said business conversation; and
recording entities and relationships between entities in a computer.

2. A method according to claim 1 further comprising:
determining by a participant that said participant is a representative of said business;
identifying one or more business conversation entities with said business or with said representative or with said participant; and
accessing said business conversation entity.

3. A method according to claim 1 further comprising:
adding one or more messages to a business conversation;
determining by a participant that said participant is a representative of said business; and
adding said business to said business conversation.

4. A method according to claim 1 further comprising:
sending one or more notifications to at least one participant or at least one business associated with a business conversation.

5. A method according to claim 1 further comprising:
adding one or more categories to a business conversation;

6. A method according to claim 1 further comprising:
identifying one or more external communication entities;
determining by a participant that said participant is a representative of said business; and
adding said business to said external communication entity.

7. A non-transitory computer-readable medium including one or more sequences of instructions which, when executed by one or more processors, cause:
creating a plurality of representative entities that track relationships between business entities and people entities;
creating one or more business conversation entities;
determining by a participant that said participant is a representative of said business;
adding said business to said business conversation; and
recording entities and relationships between entities in a computer.

8. The non-transitory computer-readable medium of claim 7, wherein the instructions cause:
determining by a participant that said participant is a representative of said business;
identifying one or more business conversation entities with said business or with said representative or with said participant; and
accessing said business conversation entity.

9. The non-transitory computer-readable medium of claim 7, wherein the instructions cause:
adding one or more messages to a business conversation;
determining by a participant that said participant is a representative of said business; and
adding said business to said business conversation.

10. The non-transitory computer-readable medium of claim 7, wherein the instructions cause:
sending one or more notifications to at least one participant or at least one business associated with a business conversation.

11. The non-transitory computer-readable medium of claim 7, wherein the instructions cause:
adding one or more categories to a business conversation.

12. The non-transitory computer-readable medium of claim 7, wherein the instructions cause:
identifying one or more external communication entities;
determining by a participant that said participant is a representative of said business; and
adding said business to said external communication entity.

13. A system comprising:
one or more processors; and
a non-transitory computer-readable medium including one or more sequences of instructions which, when executed by one or more processors, cause:
creating a plurality of representative entities that track relationships between business entities and people entities;
creating one or more business conversation entities;
determining by a participant that said participant is a representative of said business;
adding said business to said business conversation; and
recording entities and relationships between entities.

14. The system of claim 13, wherein the instructions cause:
determining by a participant that said participant is a representative of said business;
identifying one or more business conversation entities with said business or with said representative or with said participant; and
accessing said business conversation entity.

15. The system of claim 13, wherein the instructions cause:
adding one or more messages to a business conversation;
determining by a participant that said participant is a representative of said business; and
adding said business to said business conversation.

16. The system of claim 13, wherein the instructions cause:
sending one or more notifications to at least one participant or at least one business associated with a business conversation.

17. The system of claim 13, wherein the instructions cause:
adding one or more categories to a business conversation.

18. The system of claim 13, wherein the instructions cause:
identifying one or more external communication entities;
determining by a participant that said participant is a representative of said business; and
adding said business to said external communication entity.
